(19) United States
(12) Patent Application Publication
(10) Pub. No.: US 2023/0033708 A1
(43) Pub. Date: Feb. 2, 2023

(54) SYSTEMS AND METHODS FOR LOADING REAGENT-CONTAINING MICROFLUIDIC CHIPS

(71) Applicants: thinXXS Microtechnology GmbH, Zweibrücken (DE); Pattern Bioscience, Inc., Austin, TX (US)

(72) Inventors: Lutz WEBER, Zweibrücken (DE); Ross JOHNSON, Austin, TX (US)

(73) Assignees: thinXXS Microtechnology GmbH, Zweibrücken (DE); Pattern Bioscience, Inc., Austin, TX (US)

(21) Appl. No.: 17/815,957

(22) Filed: Jul. 29, 2022

Related U.S. Application Data
(60) Provisional application No. 63/227,303, filed on Jul. 29, 2021.

(51) Int. Cl. B01L 3/00

(52) U.S. Cl. CPC B01L 3/502715; B01L 2300/0672; B01L 2300/044; B01L 2300/047; B01L 2400/0487; B01L 2200/16; B01L 2300/0829

(57) ABSTRACT

A microfluidic device can include a microfluidic circuit that comprises an inlet port, a reagent-containing chamber configured to receive fluid from the inlet port, a non-aqueous-liquid-containing reservoir configured to receive liquid from the chamber, and a droplet-generating region configured to receive and produce droplets of liquid from the reservoir. The circuit can also include first and second valves or frangible members. The first valve or frangible member can have closed position in which fluid is prevented from entering or exiting the chamber therethrough and an open position in which fluid is permitted to enter or exit the chamber therethrough. The second valve or frangible member can have a closed position in which fluid is prevented from flowing between the chamber and the reservoir therethrough and an open position in which fluid is permitted to flow between the chamber and the reservoir therethrough.

### CROSS REFERENCE TO RELATED APPLICATIONS

The present application claims the benefit of priority to U.S. provisional patent application No. 63/227,303, filed Jul. 29, 2021, which is incorporated herein by reference in its entirety.

### FIELD OF INVENTION

The present invention relates generally to loading microfluidic chips and, specifically, to loading microfluidic chips for reagent testing.

### BACKGROUND

Microfluidic chips have gained increased use in a wide variety of fields, including cosmetics, pharmaceuticals, pathology, chemistry, biology, and energy. A microfluidic chip typically has one or more channels that are arranged to transport, mix, and/or separate one or more samples for analysis thereof. At least one of the channel(s) can have a dimension that is on the order of a micrometer or tens of micrometers, permitting analysis of comparatively small (e.g., nanoliter or picoliter) sample volumes. The small sample volumes used in microfluidic chips provide a number of advantages over traditional bench top techniques. For example, more precise biological measurements, including the manipulation and analysis of single cells and/or molecules, may be achievable with a microfluidic chip due to the scale of the chip's components. Microfluidic chips can also provide improved control of the cellular environment therein to facilitate experiments related to cellular growth, aging, antibiotic resistance, and the like. And microfluidic chips, due to their small sample volumes, low cost, and disposability, are well-suited for diagnostic applications, including identifying pathogens and point-of-care diagnostics.

In some applications, microfluidic chips are configured to generate droplets to facilitate analysis of a sample. Traditionally, such chips are loaded by increasing pressure at the chip's inlet port to cause liquid to flow toward the chip's test volume and form droplets that enter the test volume. During this process, the pressure in the test volume increases above ambient pressure. If there is a need for subsequent processing of the droplets within the microfluidic chip outside of the instrument, the pressure in the test volume must be returned to ambient pressure or sealed to prevent flow of the droplets outside of the test volume. This depressurization process can be time-consuming to mitigate droplet coalescence and sealing the test volume adds significant complexity.

It can be valuable to test the impact of multiple reagents on the sample. For example, for antibiotic susceptibility testing, testing multiple antibiotics may allow the selection of an antibiotic most effective at inhibiting microbe growth to treat an infection. Traditionally, such testing is performed by placing different reagents in individual wells of a test apparatus and introducing a portion of the sample into each of the wells manually using a pipette or with a robot. However, such a process is susceptible to errors and can be expensive and complex.

In droplet microfluidics, droplets can encapsulate cells or molecules under investigation to, in effect, amplify the concentration thereof and to increase the number of reactions. Droplet-based microfluidic chips accordingly have good potential for high-throughput reagent testing such as antibiotic susceptibility tests, even with the above-described chip loading inefficiencies. To test a reagent's interaction with a sample (e.g., an antibiotic's ability to inhibit microbe growth), the reagent is introduced into the sample. Some have done so by introducing the reagent(s) into the device during the test, such as by generating a set of droplets from a test-reagent-containing liquid and merging those droplets with droplets generated from the sample liquid. Adding reagents during the test, however, can decrease testing throughput and add complexity to the testing process.

### SUMMARY

There accordingly is a need in the art for apparatuses and methods to efficiently load a sample into a microfluidic device and introduce one or more reagents to the sample. To address this need, some of the present microfluidic devices can be pre-loaded with one or more reagents and configured such that a sample can flow to each of the reagent(s). The microfluidic device can include at least one inlet port and, for each of the reagent(s), a chamber that contains the reagent and is configured to receive fluid from at least one of the inlet port(s). Additionally, for each chamber, the microfluidic device can comprise a reservoir containing a non-aqueous liquid and first and second isolating members (e.g., valves or frangible members) that each have a closed position and an open position.

For each chamber, the reagent can be introduced to the sample by increasing pressure at the inlet port(s) in fluid communication with the chamber such that sample in the inlet port(s) flows into the chamber. Before this pressure increase, pressure is preferably reduced at the inlet port(s) such that gas flows from the chamber and out of the inlet port(s). The first and second isolating members can be closed during this loading such that fluid cannot enter or exit the chamber through the first isolating member and fluid cannot flow between the chamber and the reservoir through the second isolating member. The closed isolating members can thus prevent fluid flow to and from the chamber other than that which occurs along one or more flow paths that place the chamber in fluid communication with the inlet port(s), which facilitates the formation of pressure gradients that cause the above-described flow during loading.

Droplets can be generated from the sample after the sample is received in the chamber. To do so, the first and second isolating members can be opened (e.g., by puncturing them, if they comprise a frangible member) such that fluid can enter or exit the chamber through the first isolating member and fluid can flow between the chamber and reservoir through the second isolating member. With the isolating members opened, the sample liquid with the reagent introduced thereto can enter the reservoir and loading for droplet generation can be performed by increasing pressure at the first isolating member such that at least a portion of the sample and at least a portion of the non-aqueous liquid flows from the reservoir and through a droplet-generating region of the microfluidic device to form droplets for analysis. Pressure is preferably reduced at the opened first isolating member before pressure is increased such that gas flows from the droplet-generating region, through the reservoir, and through the chamber.

Because the reagent(s) need not be introduced into the microfluidic device with the sample, reagent testing can be simpler and more efficient. It can also be more reliable than the traditional pipetting technique. And the two-step loading process—first to introduce reagent to the sample, and second to generate droplets—facilitates consistency in the amount of sample introduced into the microfluidic device. For example, when multiple reagents are tested in the microfluidic device, such consistency can allow substantially the same amount of sample to be received in each chamber to promote an accurate analysis when comparing the reagents' effects thereon. Furthermore, when gas is evacuated before liquid is introduced into the microfluidic device, pressure within the microfluidic device can return to ambient pressure when the sample flows therein. Post-loading droplet movement can thus be mitigated without the time-consuming return to ambient pressure that is performed with conventionally-loaded microfluidic devices.

Some of the present microfluidic devices include a microfluidic circuit that includes an inlet port, a chamber configured to receive fluid from the inlet port, the chamber containing a reagent, and a first valve or frangible member. The first valve or frangible member, in some embodiments, have a closed position in which fluid is prevented from entering or exiting the chamber through the first valve or frangible member and an open position in which fluid is permitted to enter or exit the chamber through the first valve or frangible member. In some embodiments, the first valve or frangible member comprises a first fluid-impermeable membrane.

In some embodiments, the microfluidic circuit includes a reservoir configured to receive liquid from the chamber. The reservoir, in some embodiments, contains a non-aqueous liquid. In some embodiments, the microfluidic circuit includes a second valve or frangible member having a closed position in which fluid is prevented from flowing between the chamber and the reservoir through the second valve or frangible member and an open position in which fluid is permitted to flow between the chamber and the reservoir through the second valve or frangible member. The second valve or frangible member, in some embodiments, comprises a second fluid-impermeable membrane. In some embodiments, the first fluid-impermeable membrane and the second fluid-impermeable membrane are aligned such that an axis extends through each.

The microfluidic circuit, in some embodiments, includes a droplet-generating region configured to receive and produce droplets of liquid from the reservoir. The droplet-generating region, in some embodiments, includes a flow path having a minimum cross-sectional area that increases along the flow path in a direction away from the reservoir.

In some embodiments, the microfluidic circuit comprises a third valve or frangible member that separates the chamber into a first portion and a second portion. The third valve or frangible member, in some embodiments, has a closed position in which gas, but not liquid, is permitted to flow between the first and second portions through the third valve or frangible member and an open position in which fluid is permitted to flow between the first and second portions through the third valve or frangible member. In some embodiments, the third valve or frangible member comprises an air-permeable membrane. In some embodiments, the first fluid-impermeable membrane, the second fluid-impermeable membrane, and the air-permeable membrane are aligned such than an axis extends through each. The air-permeable membrane, in some embodiments, comprises the reagent.

In some embodiments, the microfluidic device comprises a penetrator. The penetrator, in some embodiments, is movable relative to the membranes along the axis, the penetrator configured to puncture the membranes such that the membranes are in the open position.

Some of the present methods of loading a microfluidic device comprise disposing an aqueous liquid within an inlet port of the microfluidic device and introducing a reagent to the aqueous liquid. In some embodiments, introducing the reagent is performed at least by reducing pressure at the inlet port such that gas flows from a chamber of the microfluidic device that contains a reagent and out of the inlet port and increasing pressure at the inlet port such that at least a portion of the aqueous liquid flows from the inlet port and into the chamber.

Some methods comprise generating droplets of the aqueous liquid at least by opening first and second ports, each in fluid communication with the chamber. In some methods, generating droplets comprises reducing pressure at the first port such that gas flows from a droplet-generating region of the microfluidic device, through a reservoir of the microfluidic device that contains a non-aqueous liquid, and through the chamber via the first and second ports. In some methods, generating droplets comprises increasing pressure at the first port such that at least a portion of the aqueous liquid and at least a portion of the non-aqueous liquid flow from the reservoir and through the droplet-generating region. The droplet-generating region, in some methods, includes a flow path having a minimum cross-sectional area that increases along the flow path in a direction away from the reservoir.

In some methods, opening the first and second ports comprises opening a first valve or frangible member that otherwise prevents fluid from flowing through the first port and entering the chamber or exiting the chamber and flowing through the first port and opening a second valve or frangible member that otherwise prevents fluid from flowing through the second port and entering the chamber or exiting the chamber and flowing through the second port.

In some methods, for each of the valves or frangible members, the valve or frangible member comprises a membrane and opening the valve or frangible member comprises puncturing the membrane.

In some methods, the device comprises a valve or membrane in fluid communication with the chamber. In some of such methods, increasing pressure at the inlet port is performed such that gas, but not liquid, flows through the valve or membrane.

In some methods, the device comprises a third valve or frangible member that separates the chamber into a first portion and a second portion. In some of such methods, increasing pressure at the inlet port is performed such that gas, but not liquid, flows between the first and second portions through the third valve or frangible member. Generating droplets of the aqueous liquid, in some methods, comprises opening the third valve or frangible member such that liquid is permitted to flow between the first and second portions through the third valve or frangible member.

Some devices for introducing a liquid to a reagent, the liquid for receipt by a microfluidic chip, comprise a body having an interior volume and an end including a first opening in fluid communication with the interior volume. Some devices include a reagent disposed within the interior volume. In some devices, the body is configured to be coupled to a port of a microfluidic chip such that the end receives or is received by the port and the body includes a passageway configured to permit liquid to flow into the interior volume to contact the reagent without flowing out of the port.

In some devices, the body includes a second opening in fluid communication with the interior volume. Some devices comprise a first valve or frangible member having a closed position in which fluid is prevented from entering or exiting the interior volume through the first valve or frangible member and an open position in which fluid is permitted to enter and exit the interior volume through the first valve or frangible member. Some devices comprise a second valve or frangible member that separates the interior volume into a first portion and a second portion, the second valve or frangible member having a closed position in which gas, but not liquid, is permitted to flow between the first and second portions through the second valve or frangible member and an open position in which fluid is permitted to flow between the first and second portions through the second valve or frangible member. The passageway, in some devices, is configured to permit liquid to flow into the first portion to contact the reagent without flowing out of the port.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” “include” and any form thereof such as “includes” and “including,” and “contain” and any form thereof such as “contains” and “containing,” are open-ended linking verbs. As a result, an apparatus that “comprises,” “has,” “includes,” or “contains” one or more elements possesses or contains those one or more elements, but is not limited to possessing or containing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale, unless otherwise noted, meaning the sizes of the depicted elements are accurate relative to each other for at least the embodiment in the view.

FIG. 1A is a perspective view of one of the present microfluidic devices that is pre-loaded with one or more reagents and can be vacuum loaded.

FIGS. 1B-1E are side, front, rear, and bottom views, respectively, of the microfluidic device of FIG. 1A.

FIG. 2 is a perspective view of the microfluidic device of FIG. 1A with the lid thereof removed.

FIG. 3 is a perspective view of the microfluidic device of FIG. 1A with the outer shell thereof removed; FIG. 3 illustrates the relative positioning of the microfluidic device's penetrator assembly and microfluidic chips.

FIG. 4A is a perspective view of one of the microfluidic chips of the microfluidic device of FIG. 1A.

FIG. 4B is a bottom view of the chip of FIG. 4A and illustrates the test volumes thereof.

FIG. 4C is a sectional view of the chip of FIG. 4A taken along line 4C-4C.

FIG. 4D is a sectional view of the chip of FIG. 4A taken along line 4D-4D.

FIG. 5A is a bottom view of a plug device of the FIG. 1A microfluidic device that is configured to be attached to the microfluidic chip to define the chamber containing a reagent.

FIG. 5B is a top view of the plug device of FIG. 5A without the overflow cap thereof.

FIG. 6A is a bottom view of a portion of the chip of FIG. 4A and illustrates a droplet-generating region and test volume thereof.

FIG. 6B is a sectional view of the chip of FIG. 4A taken along line 6B-6B of FIG. 6A and illustrates the droplet-generating region thereof.

FIG. 7A is a sectional view of the FIG. 4A microfluidic chip with an aqueous sample liquid disposed in a receptacle thereof.

FIG. 7B is a sectional view of the FIG. 4A microfluidic chip and illustrates gas evacuation through the sample during vacuum loading.

FIG. 7C is a sectional view of the FIG. 4A microfluidic chip and illustrates the flow of sample into the chamber defined by one of the plug devices that are coupled to the chip.

FIG. 7D is a sectional view of the FIG. 4A microfluidic chip and illustrates the penetrator assembly puncturing first and second frangible members to open first and second ports thereof.

FIG. 7E is a sectional view of the FIG. 4A microfluidic chip and illustrates sample flow into the reservoir.

FIG. 7F is a sectional view of the FIG. 4A microfluidic chip and illustrates gas evacuation through the sample and non-aqueous liquid disposed in the reservoir during vacuum loading.

FIG. 7G is a sectional view of the FIG. 4A microfluidic chip and illustrates droplet formation in the chip's droplet-generating region.

FIG. 8 is a schematic illustrating the FIG. 1A microfluidic device disposed in a loading chamber that can be used to load the sample into the device's microfluidic chips.

### DETAILED DESCRIPTION

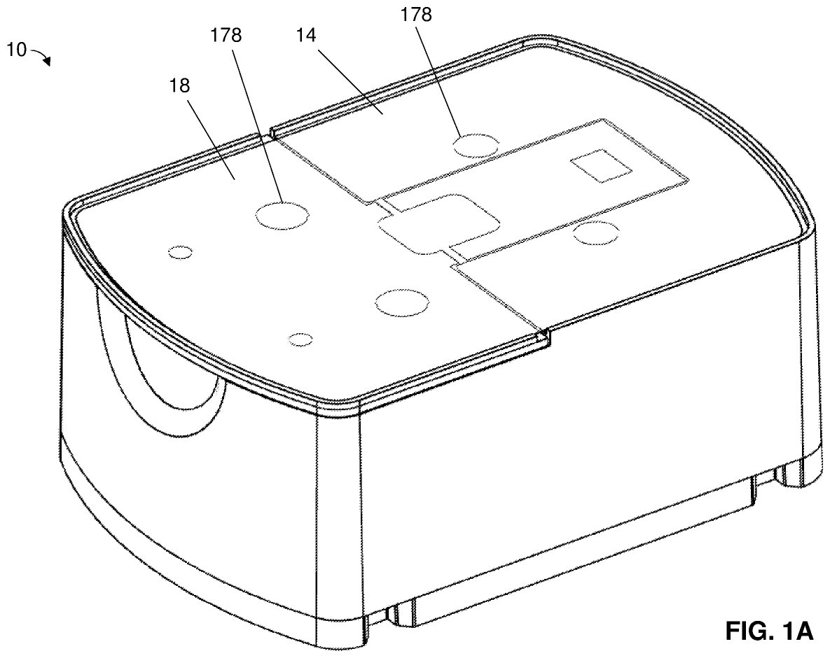

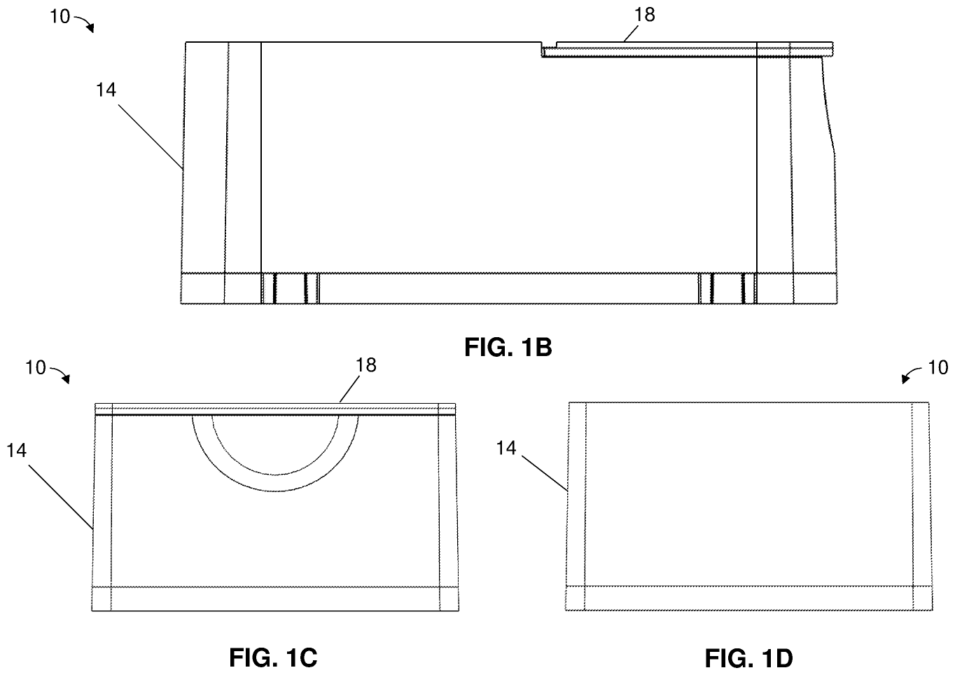

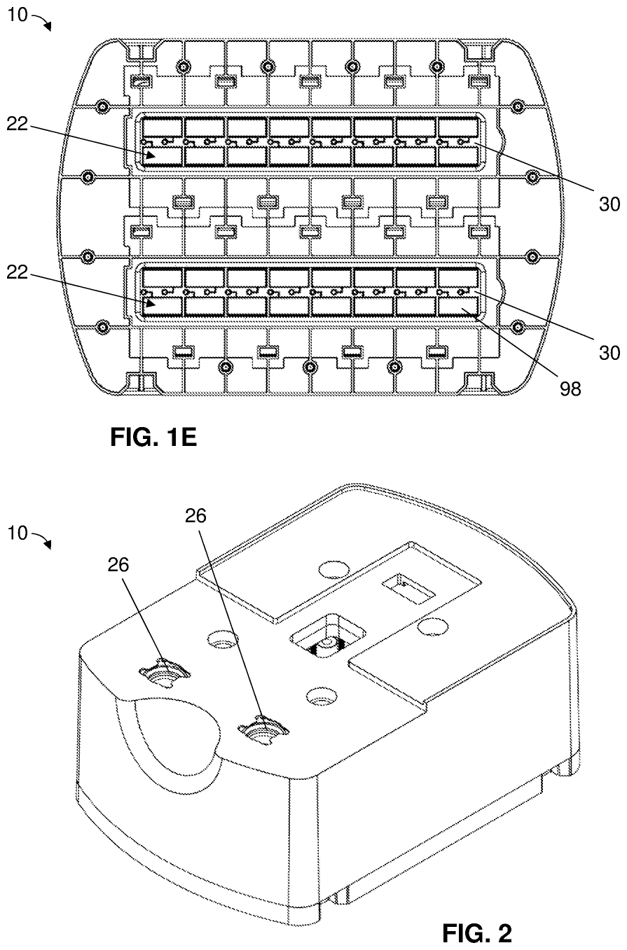

Referring to FIGS. 1A-1E, shown is an embodiment 10 of the present microfluidic devices for introducing one or more reagents to a sample. Device 10 can include a shell 14 and one or more microfluidic circuits 22, such as greater than or equal to any one of, or between any two of, 1, 2, 3, 4, 5, 6, 7, or 8 microfluidic circuits; as shown, the device includes two microfluidic circuits. Turning additionally to FIG. 2, each of microfluidic circuit(s) 22 can include at least one inlet port 26 that can receive a liquid sample for analysis. Device 10 can comprise a lid 18 that is movable (e.g., pivotable or removable) between a closed position in which the lid engages inlet port(s) 26 and an open position in which liquid can be introduced into the inlet port(s). As described in further detail below, each microfluidic circuit 22 can contain one or more reagents and can be configured such that sample introduced into inlet port(s) 26 can flow to each of the reagent(s) and into a test volume 98 in which the interaction between the sample and reagent can be analyzed.

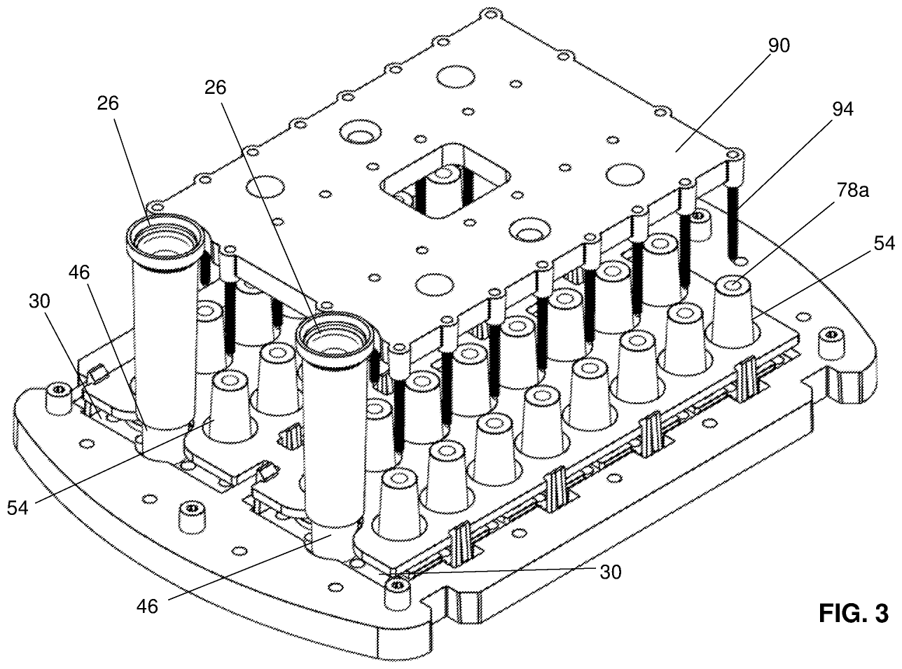

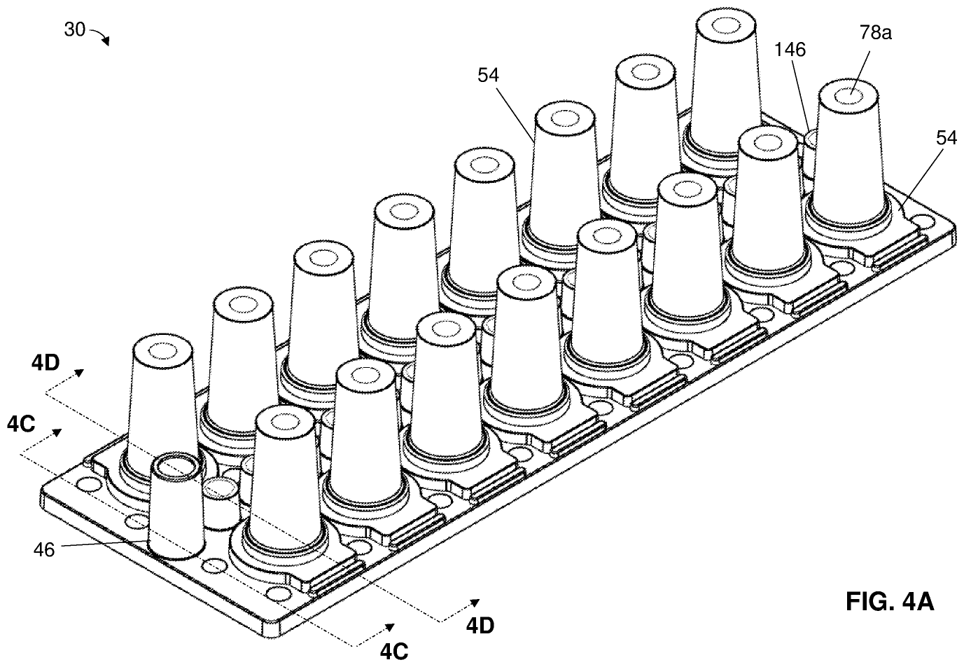

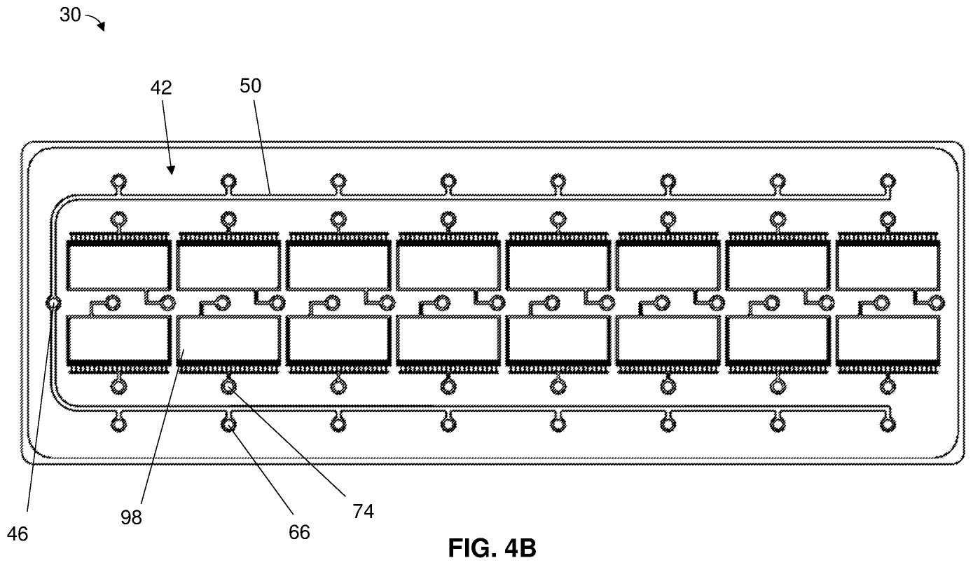

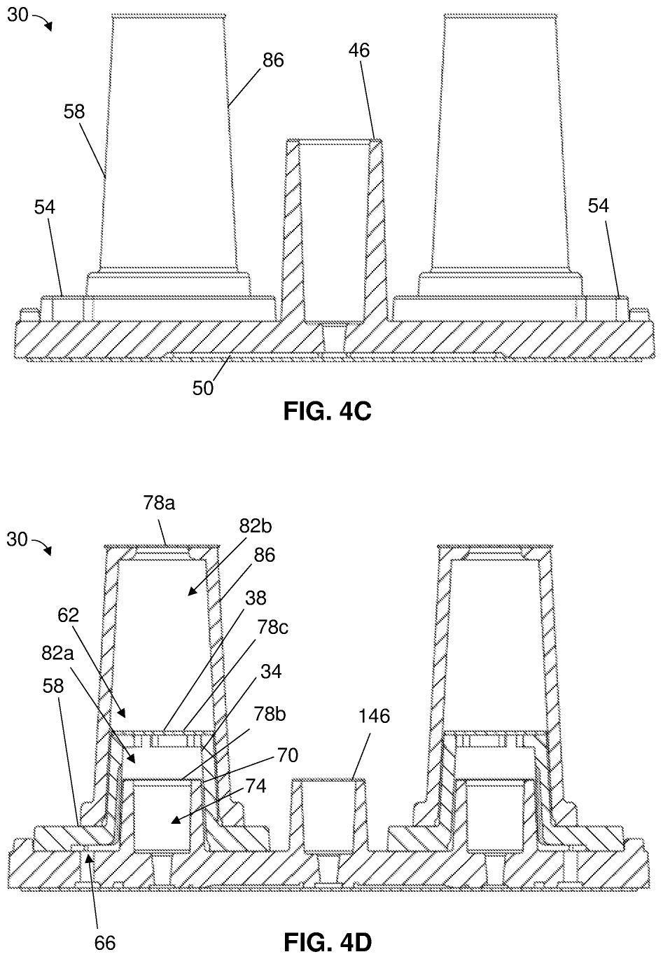

Referring to FIG. 3—which shows device 10 with a portion of shell 14 removed—microfluidic circuit(s) 22 can be at least in part defined by one or more—optionally two or more—microfluidic chips 30 in the shell. As shown, device 10 comprises two microfluidic chips 30, each defining a portion of a respective one of circuits 22. Referring further to FIGS. 4A-4D, each microfluidic circuit 22 can include one or more chambers 34, wherein at least one of the chamber(s) contains a reagent 38 (FIG. 4D). To permit analysis of multiple reagents 38, device 10's microfluidic circuit(s) 22 can have multiple chambers 34—whether part of a single circuit or part of multiple circuits—such as greater than or equal to any one of, or between any two of, 2, 3, 4, 6, 8, 10, 12, 14, 16, 20, 24, 28, or 32 chambers. For example, in the embodiment shown each of the two microfluidic circuits 22 has sixteen chambers 34 such that device 10 includes thirty-two chambers in total. At least one of chambers 34 can omit a reagent (e.g., such that a control analysis can be performed) and other ones of the chambers can have different reagents 38.

To allow each reagent 38 to be introduced to a sample, each chamber 34 can be in fluid communication with at least one inlet port 26 of its microfluidic circuit 22. Such fluid communication can be achieved via a flow path 42 that extends between inlet port 26 and chamber 34. As shown, for example, flow path 42 can include a receptacle 46 of chip 30 that is coupled to inlet port 26 (FIGS. 3 and 4A) such that the receptacle can receive sample therefrom. Flow path 42 can further comprise one or more channels 50 that extend between receptacle 46 and a passageway 66 through which fluid can enter chamber 34 (FIGS. 4B-4D). To illustrate, for each microfluidic circuit 22, a portion of liquid sample from an inlet port 26 can flow to receptacle 46, through channel(s) 50, and, for each chamber 34, through passageway 66 and into the chamber.

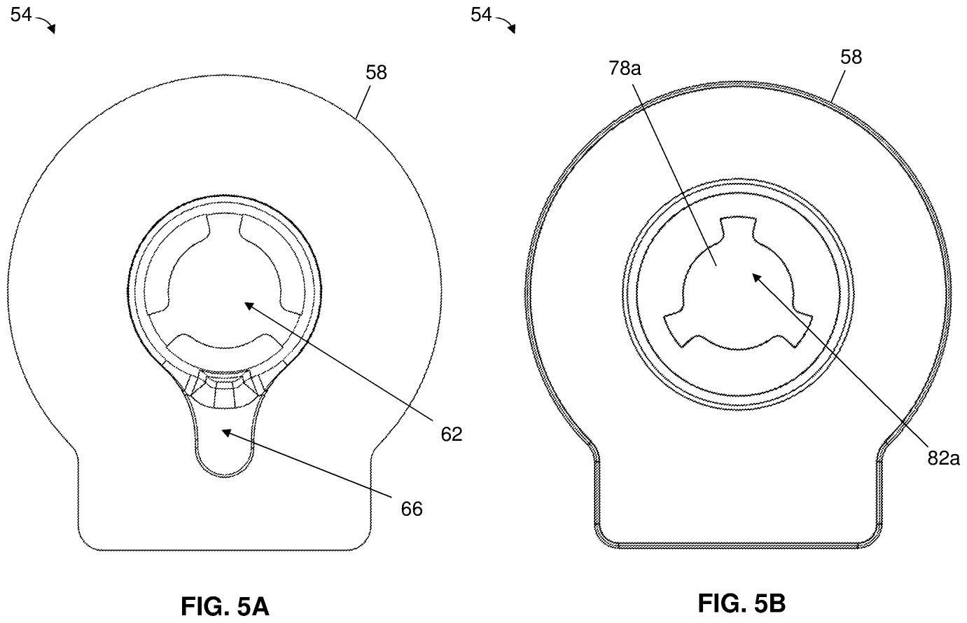

Each chamber 34 can be defined by a plug device 54 coupled to microfluidic chip 30. As illustrated further in FIGS. 5A and 5B, plug device 54 can comprise a body 58 having an interior volume 62 that includes chamber 34. An end of body 58 can define an opening that is in communication with interior volume 62 and can receive or be received by an inlet port 70 of chip 30. When coupled to chip inlet port 70, plug device 54's body 58 can also define passageway 66 which, as described above, allows sample liquid from one of chip 30's channel(s) 50 to enter chamber 34 (e.g., without flowing out of the chip inlet port) to contact a reagent 38, if present, in the chamber. Chip inlet port 70 can define a reservoir 74 that, as described in further detail below, can be configured to receive sample liquid from chamber 34 and can contain a non-aqueous liquid (e.g., 194) for droplet generation.

Each microfluidic circuit 22 can comprise, for each chamber 34, at least first and second isolating members 78a and 78b—and, optionally, a third isolating member 78c—that facilitate sample loading into the chamber and prevent sample from entering reservoir 74 during reagent introduction. First, second, and third isolating members 78a-78c can each have closed and open positions. When first isolating member 78a is in the closed position, fluid is prevented from entering or exiting chamber 34 through the first isolating member. Accordingly, when microfluidic device 10 is exposed to a change in pressure, the change in pressure may be communicated to inlet port(s) 26 but not through closed isolating member 78a, which can yield a pressure gradient that causes fluid to flow between inlet port(s) 26 and chamber 34. When second isolating member 78b is in the closed position, fluid is prevented from flowing between chamber 34 and reservoir 74 through the second isolating member such that the sample can fill the chamber before entering the reservoir. This can prevent liquid from flowing into the portion of microfluidic circuit 22 downstream of reservoir 74—described in further detail below—when reagent is introduced to the sample, which can in turn facilitate metering of consistent volumes of sample into multiple chambers 34 such that each chamber contains substantially the same volume of sample for subsequent droplet generation. Additionally, closed second isolating member 78b can prevent non-aqueous liquid contained in reservoir 74 from entering chamber 34 (e.g., to prevent inadvertent contact with reagent 38 contained in the chamber).

Third isolating member 78c can further facilitate metering of consistent volumes of sample. Third isolating member 78c can separate chamber 34 into first and second portions 82a and 82b and, when in the closed position, can permit gas, but not liquid, to flow between the first and second portions. A liquid sample flowing into chamber 34 can thereby be constrained in the chamber's first portion 82a. Meanwhile, any gas in microfluidic circuit 22 that may flow to chamber 34 as sample flows therein can pass through third isolating member 78c into second portion 82b, which can be bounded by first isolating member 78a, the third isolating member, and an overflow cap 86 of plug device 54's body 58. With gas flowing into second portion 82b, sample can readily occupy the entire volume of chamber 34's first portion 82a, facilitating delivery of substantially the same volume of sample to multiple chambers even if some are filled before others. Third isolating member 78c can also comprise reagent 38 such that the reagent can be introduced to the sample when the sample fills first portion 82a and contacts the third isolating member. For example, reagent 38 can be added to third isolating member 78c before assembly of microfluidic device 10 by introducing a reagent-containing liquid thereto and drying (e.g., through lyophilisation) the isolating member such that the reagent remains thereon. In other embodiments, however, chamber 34 need not include third isolating member 78c such that it is not partitioned into first and second portions 82a and 82b; in some of such embodiments, first isolating member 78a can permit gas, but not liquid, to enter or exit the chamber therethrough when closed, and optionally can comprise reagent 38 (e.g., if comprising an air-permeable membrane).

First, second, and third isolating members 78a-78c can be opened such that the sample, once loaded with reagent, can enter reservoir 74 and be directed into one of device 10's test volume(s) 98 for analysis. Each of isolating members 78a-78c can comprise any suitable structure that can be opened, such as a valve or frangible member; as shown, each comprises a frangible member, with the first and second isolating members each comprising a fluid-impermeable membrane and the third isolating member comprising an air-permeable (and liquid-impermeable) membrane. To open frangible members 78a-78c, microfluidic device 10 can include a penetrator assembly 90 that comprises, for each chamber 34, a penetrator 94 (FIG. 3). Penetrator assembly 90 can be movable from a first position in which each chamber 34's frangible members 78a-78c are closed to a second position in which each of the assembly's penetrator(s) 94 puncture the frangible members of a respective one of the chamber(s) to open them. For example, microfluidic device 10's shell 14 can include one or more openings 178 through which a plunger can pass to engage and thereby move penetrator assembly 90 to the second position. For each chamber 34, frangible members 78a-78c can be aligned such that an axis extends through each, which allows a penetrator 94 aligned with the axis to penetrate them.

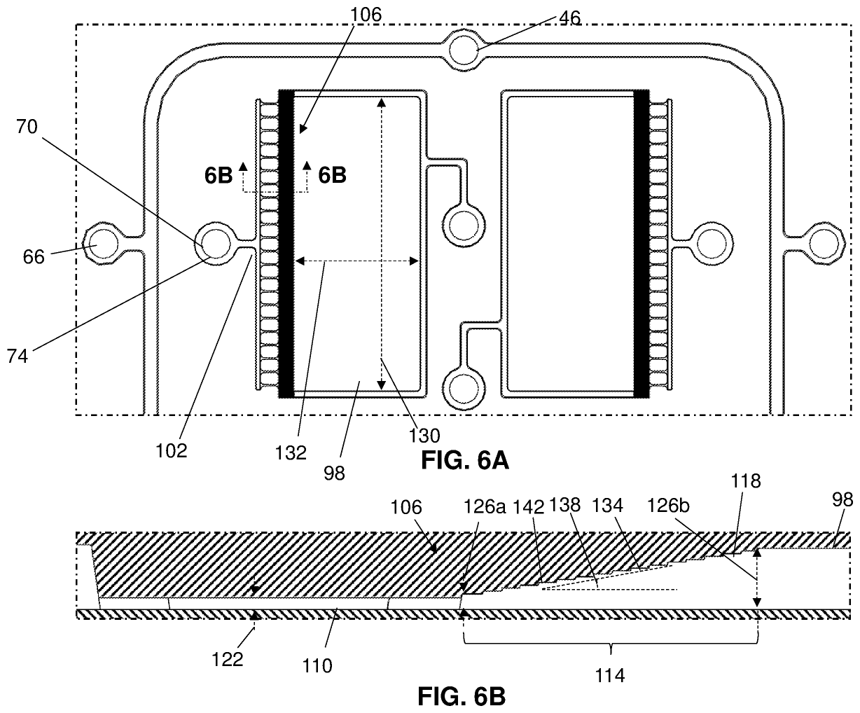

Referring additionally to FIGS. 6A and 6B, each microfluidic circuit 22 can have, for each of its chamber(s) 34, a testing portion that includes reservoir 74 (e.g., defined by chip inlet port 70), test volume 98, and one or more flow paths 102 extending between the reservoir and the test volume. Each flow path 102 can include a droplet-generating region 106 and, along the flow path, fluid can flow from reservoir 74, through the droplet-generating region, and to test volume 98 such that droplets are formed and introduced into the test volume for analysis. Each flow path 102 can be defined by one or more channels and/or other passageways through which fluid can flow, and can have any suitable maximum transverse dimension to facilitate microfluidic flow, such as, for example, a maximum transverse dimension, taken perpendicularly to the centerline of the flow path, that is less than or equal to any one of, or between any two of, 2,000, 1,500, 1,000, 500, 300, 200, 100, 50, or 25 μm. Each testing portion of each microfluidic network 22 optionally includes an outlet port 146 that at least some (e.g., excess) droplets can enter from test volume 98; the outlet port can be sealed to prevent fluid from entering or exiting the outlet port except via the flow path(s) between the outlet port and the test volume.

Droplet generation can be achieved in any suitable manner. For example, as shown in FIG. 6B, in droplet-generating region 106 a minimum cross-sectional area of flow path 102 can increase along the flow path in a direction away from reservoir 74. To illustrate, flow path 102 can include a constricting section 110 and an expansion region 114, where a minimum cross-sectional area of the flow path is larger in the expansion region than in the constricting section. As such, liquid including aqueous sample in the presence of a non-aqueous liquid can expand to form droplets when it flows along flow path 102 from constricting section 110 to expansion region 114.

Such a change in the cross-sectional area of flow path 102 can result from variations in the depth of the flow path. For example, in expansion region 114, flow path 102 can include a constant section (e.g., along which the depth of the flow path is substantially the same) and/or an expanding section (e.g., along which the depth of the flow path increases along the flow path), maximum depth 126b of each being larger than—such as at least 10%, 50%, 100%, 150%, 200%, 250%, or 400% larger than—constricting section 110's maximum depth 122. To illustrate, constricting section 110's maximum depth 122 can be less than or equal to any one of, or between any two of, 20, 15, 10, or 5 μm (e.g., between 10 and 20 μm) and expansion region 114's maximum depth 126b can be greater than or equal to any one of, or between any two of, 15, 30, 45, 60, 75, 90, 105, or 120 μm (e.g., between 65 and 85 μm).

As shown, expansion region 114 comprises an expanding section including a ramp 118 having a slope 134 that is angularly disposed relative to constricting section 110 by an angle 138 such that the depth of the expanding section increases moving away from the constricting section (e.g., from minimum depth 126a to maximum depth 126b). Angle 138 can be greater than or equal to any one of, or between any two of, 5°, 10°, 20°, 30°, 40°, 50°, 60°, 70°, or 80° (e.g., between 20° and 40°), as measured relative to a direction parallel to the centerline of constricting section 110. As shown, ramp 118 is defined by a plurality of steps 142 having a rise and run such that the ramp has any of the above-described slopes 134; in other embodiments, however, the ramp can be defined by a single, planar surface.

Droplet-generating region 106 can have other configurations to form droplets. For example, in other embodiments expansion of liquid can be achieved with a constant section alone, a constant section upstream of an expanding section, or an expanding section upstream of a constant section. And in other embodiments droplet-generating region 106 can be configured to form droplets via a T-junction (e.g., at which two channels—aqueous liquid flowing through one and non-aqueous liquid flowing through the other—connect such that the non-aqueous liquid shears the aqueous liquid to form droplets), flow focusing, co-flow, and/or the like. In some of such alternative embodiments, each of microfluidic network(s) 22 can include multiple chip inlet ports 70 and aqueous and non-aqueous liquids can be received in different inlet ports (e.g., such that they can meet at a junction for droplet generation).

Due at least in part to the geometry of droplet-generating region 106, droplets generated therein can have a relatively low volume, such as, for example, a volume that is less than or equal to any one of, or between any two of, 10,000, 5,000, 1,000, 500, 400, 300, 200, 100, 75, or 25 picoliters (pL) (e.g., between 25 and 500 pL). Each droplet can have, for example, a diameter that is less than or equal to any one of, or between any two of, 100, 95, 90, 85, 80, 75, 70, 65, or 60 μm (e.g., between 60 and 85 μm). The relatively low volume of droplets can facilitate analysis of, for example, microorganisms contained by the aqueous sample liquid. During droplet generation, each of one or more of the microorganisms can be encapsulated by one of the droplets (e.g., such that each of the encapsulating droplets includes a single microorganism and, optionally, progeny thereof). The concentration of encapsulated microorganism(s) in the droplets can be relatively high due to the small droplet volume, which may permit detection thereof without the need for a lengthy culture to propagate the microorganisms(s).

Droplets from droplet-generating region 106 can flow to test volume 98, which can have a droplet capacity that accommodates sufficient droplets for analysis. For example, test volume 98 can be sized to accommodate greater than or equal to any one of, or between any two of, 1,000, 5,000, 10,000, 20,000, 30,000, 40,000, 50,000, 60,000, 70,000, 80,000, 90,000, or 100,000 droplets (e.g., between 13,000 and 25,000 droplets). To do so, test volume 98 can have a length and width 130 and 132 that are each large relative to its maximum depth, such as a length and width that are each at least 10, 20, 30, 40, 50, 60, 70, 80, 90, 100, 110, or 120 times as large as the test volume's maximum depth. By way of example, length 130 and width 132 can each be greater than or equal to any one of, or between any two of, 3, 4, 5, 6, 7, 8, 9, 10, 11, 12, 13, 14, 15, 16, or 17 mm; as shown, the length is larger than the width (e.g., the length is between 11 and 15 mm and the width is between 5 and 9 mm). Test volume 98's depth can accommodate droplets (e.g., without compressing the droplets) while mitigating droplet stacking. Its depth can be, for example, greater than or equal to any one of, or between any two of, 15, 30, 45, 60, 75, 90, 105, or 120 μm (e.g., between 15 and 90 μm, such as between 65 and 85 μm) (e.g., substantially the same as maximum depth 126b of expansion region 114) and, optionally, can be substantially the same across test volume 98.

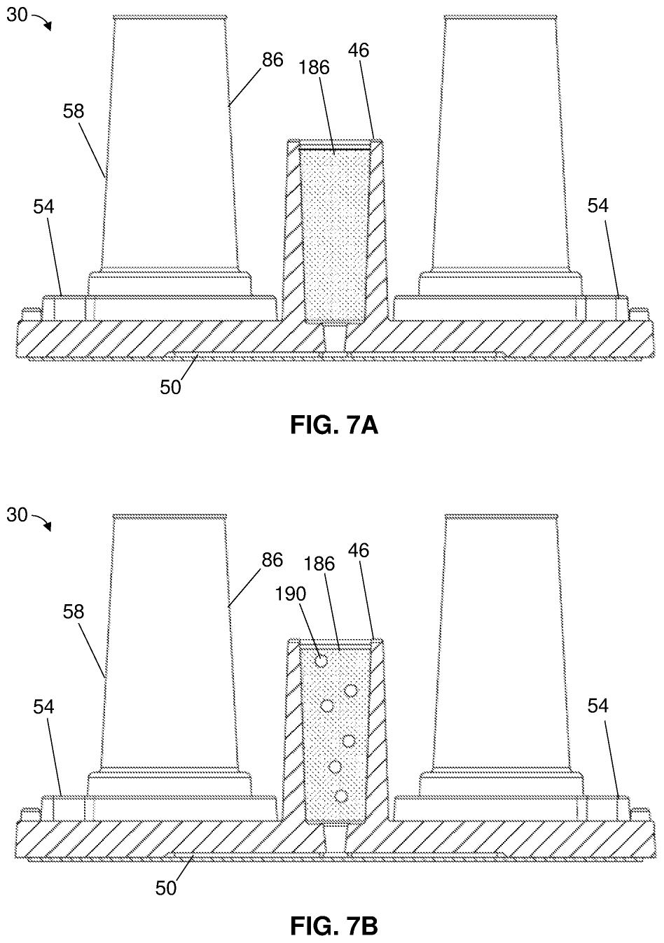

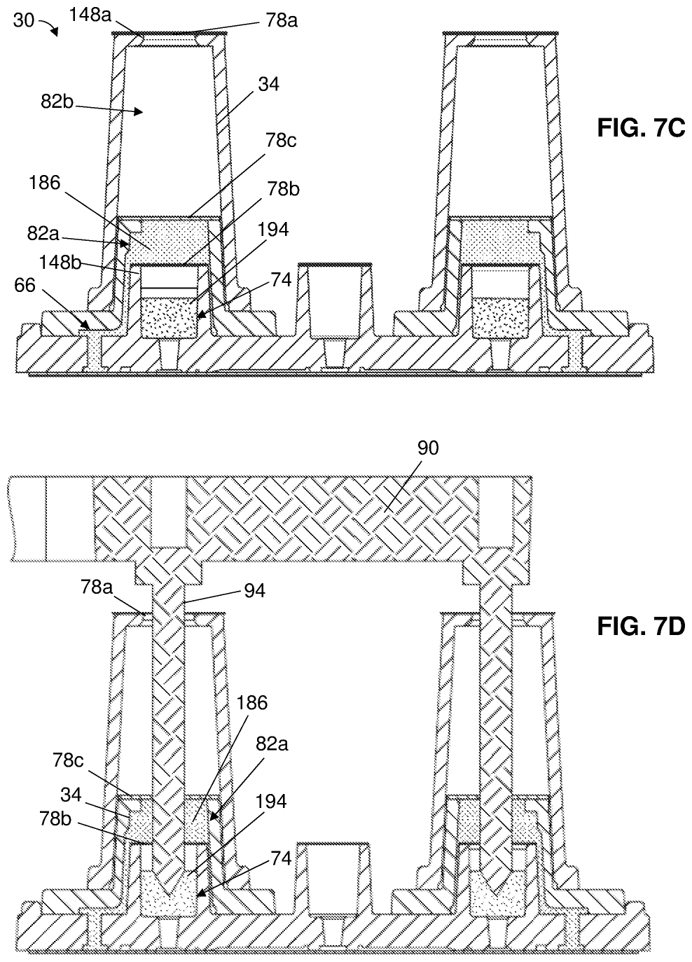

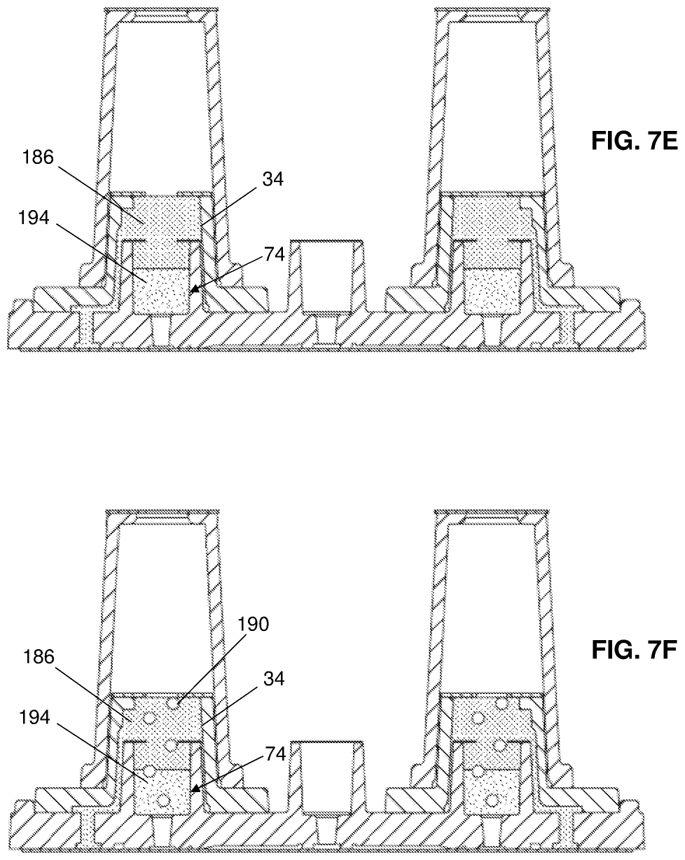

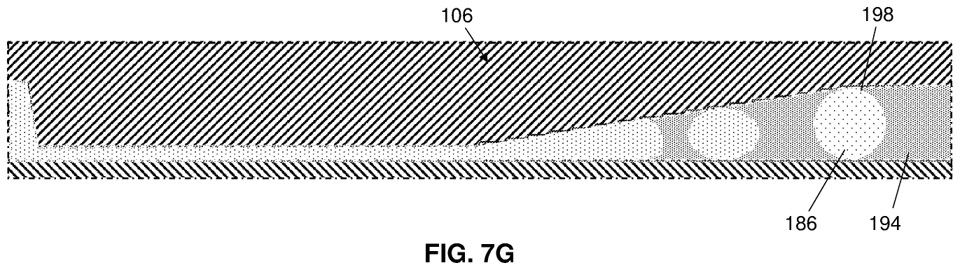

Referring to FIGS. 7A-7G, to load a microfluidic device (e.g., 10) (e.g., any of those described herein), some methods comprise disposing an aqueous liquid (e.g., 186) (e.g., a liquid containing a sample for analysis, such as urine, saliva, blood, soft tissue, mucus, and/or the like from a patient) within one or more inlet ports (e.g., 26) thereof. As described above, aqueous liquid within an inlet port can flow into a receptacle (e.g., 46) of a chip (e.g., 30) that is in fluid communication with the inlet port (FIG. 7A).

Some methods comprise introducing one or more—optionally two or more—reagents (e.g., 38) to the aqueous liquid, each of the reagent(s) contained within a respective one of one or more chamber(s) (e.g., 34) of the microfluidic device. For example, the aqueous liquid can contain one or more microorganisms and each of the reagent(s) can comprise a drug such as an antibiotic (e.g., an antibacterial or an antifungal) such that the microfluidic device can be used to assess the ability of the antibiotic(s) to kill or inhibit the growth of the microorganism(s). Vacuum loading can be used to introduce the reagent(s) to the aqueous liquid. As shown, with vacuum loading, some methods comprise reducing pressure at each of the inlet port(s) such that, for each of the chamber(s) in fluid communication with the inlet port, gas (e.g., 190) flows from the chamber and out of the inlet port (e.g., through the aqueous liquid disposed therein) (FIG. 7B). The pressure at the inlet port(s) can be reduced below ambient pressure. For example, reducing pressure can be performed such that the pressure at the inlet port(s) is less than or equal to any one of, or between any two of, 0.5, 0.4, 0.3, 0.2, 0.1, or 0 atm. Greater pressure reductions can increase the amount of gas evacuated from each of the chamber(s).

Pressure at each of the inlet port(s) can then be increased (e.g., to ambient pressure) such that, for each of the chamber(s) in fluid communication with the inlet port, at least a portion of the aqueous liquid flows from the inlet port and into the chamber (FIG. 7C). For example, as described above, for each of the chamber(s), the portion of aqueous liquid can flow from the chip's receptacle, along one or more channels (e.g., 50), and through a passageway (e.g., 66) into the chamber. By evacuating gas before introducing liquid into the chamber, pressure within the chamber can return to ambient pressure as liquid is introduced therein, allowing subsequent steps to be performed without the need for depressurization. In other embodiments, however, positive pressure loading can be used without gas evacuation (e.g., without reducing pressure at the device(s) inlet ports before pressure is increased at the inlet port(s)).

The portion of the aqueous liquid received in a reagent-containing chamber can contact the reagent in the chamber such that the aqueous liquid includes the reagent. When the device includes multiple chambers, at least one of the chamber(s) can omit a reagent such that a control experiment can be performed.

As described above, each of the chamber(s) can include first and second—and optionally a third—isolating members (e.g., 78a-78c). The first and second isolating members can control flow through first and second ports (e.g., 148a and 148b), respectively. As shown, the first and second ports can each be in fluid communication with the chamber, wherein when open the first port allows fluid flow in and out of the chamber (without flowing through the passageway) and the second port allows fluid flow between the chamber and a reservoir (e.g., 74) containing a non-aqueous liquid (e.g., 194). For each of the chamber(s), the first and second ports can each be closed when the reagent(s) are introduced to the aqueous liquid. Accordingly, the pressure decrease and/or pressure increase communicated to the microfluidic device's inlet port(s) are not communicated into the chamber through the first port, which can facilitate fluid flow into the chamber. Further, with the second port closed, aqueous liquid received in the chamber is prevented from flowing into the reservoir before chamber loading is complete. And the third isolating member, if used, can separate the chamber into first and second portions (e.g., 82a and 82b) and permit gas, but not liquid, to pass therethrough such that when pressure at the inlet port(s) is increased the portion of aqueous liquid received in the chamber can fill and be constrained to the chamber's first portion while gas flows between the chamber's first and second portions. As described above, however, in other embodiments the chamber need not include the third isolating member such that it is not partitioned into the first and second portions, and in some of such embodiments the first isolating member can permit gas, but not liquid, to flow therethrough such that gas flows through the first isolating member when pressure is increased at the inlet port(s).

Some methods comprise, for each of the chamber(s), generating droplets of the aqueous liquid. Droplet generation can comprise, for each of the chamber(s), opening the first and second ports such that fluid can be communicated through each (e.g., by opening the first and second isolating members) (FIG. 7D). As shown, the ports are opened by puncturing the first and second isolating members (e.g., first and second frangible members, which can each be a fluid-impermeable membrane) with a penetrator (e.g., 94). The third isolating member, if present, can also be opened (e.g., by puncturing the isolating member, which can be an air-permeable membrane) to permit fluid flow thereacross such that pressure changes at the first port can more readily be communicated through the chamber and to the second port.

For each of the chamber(s), with the first and second ports opened, the aqueous liquid in the chamber can enter the reservoir through the second port (FIG. 7E) and pressure at the first port can be changed to effectuate fluid flow for droplet generation. As with reagent introduction, droplet generation can be achieved through vacuum loading. To do so, pressure at the first port can be reduced such that gas flows from a droplet-generating region (e.g., 106) of the microfluidic device, through the reservoir, and through the chamber via the first and second ports (FIG. 7F). Pressure at the first port can be reduced to below ambient pressure, e.g., such that pressure at the first port is less than or equal to any one of, or between any two of 0.5, 0.4, 0.3, 0.2, 0.1, or 0 atm. As shown, the gas can flow through the aqueous and non-aqueous liquids in the reservoir as bubbles, which can advantageously agitate and thereby mix the aqueous liquid to facilitate loading and/or analysis thereof.

Pressure at the first port can then be increased (e.g., to ambient pressure) such that at least a portion of the aqueous liquid and at least a portion of the non-aqueous liquid flow from the reservoir and through the droplet-generating region (FIG. 7G). The aqueous liquid can form droplets (e.g., 198) when passing through the droplet-generating region, which can then enter a test volume (e.g., 98) for analysis. As described above, in the droplet-generating region a flow path's minimum cross-sectional area can increase along the flow path in a direction away from the reservoir, which allows the aqueous liquid to form droplets in the presence of the non-aqueous liquid. To promote droplet generation, the non-aqueous liquid can be relatively dense compared to water, e.g., a specific gravity of the non-aqueous liquid can be greater than or equal to any one of, or between any two of, 1.3, 1.4, 1.5, 1.6, or 1.7 (e.g., greater than or equal to 1.5). With vacuum loading, as the aqueous and non-aqueous liquids enter the test volume, pressure within the test volume can increase until it reaches substantially ambient pressure.

Vacuum loading provides a number of benefits. In conventional loading techniques that use a positive pressure gradient, the test volume can be pressurized to above ambient pressure when loaded with droplets; as such, droplets loaded in that manner may tend to shift and evacuate from the test volume when the environment around the microfluidic device returns to ambient pressure. To mitigate that evacuation, conventionally-loaded devices may need seals or other retention mechanisms to keep the droplets in the test volume and the pressure in the external environment may need to be returned to ambient pressure slowly. By achieving pressure equalization between the test volume and the environment outside of the microfluidic device (e.g., to ambient pressure) using the negative pressure gradient, the position of the droplets within the test volume can be maintained for analysis without the need for additional seals or other retention mechanisms, and pressure equalization can be performed faster. Additionally, the negative pressure gradient used to load the microfluidic device can reinforce seals (e.g., between different pieces thereof) to prevent delamination and can contain unintentional leaks by drawing gas into a leak if there is a failure. Leak containment can promote safety when, for example, the aqueous liquid includes pathogens. Nevertheless, in some embodiments droplet generation can be performed using a positive pressure gradient.

Once droplets are generated and disposed in the microfluidic device's test volume(s), some methods comprise, for each of the test volume(s), capturing an image of the liquid (e.g., droplets) within the test volume. The aqueous liquid can include a fluorescent compound, such as a viability indicator (e.g., resazurin) that can have a particular fluorescence that varies over time in the presence of a microorganism. In droplets that encapsulate a microorganism, for example, the microorganism may interact with the viability indicator to exhibit a fluorescent signature. The droplets can be illuminated with one or more light sources such that droplets can exhibit such fluorescence (if any), which can be measured using the image capture to assess the impact of the reagent introduced to the aqueous liquid. For example, an antibiotic may inhibit the growth of microorganism(s) encapsulated in the droplets; fewer droplets exhibiting a fluorescent signature relative to droplets in a control test volume may evidence the antibiotic's efficacy.

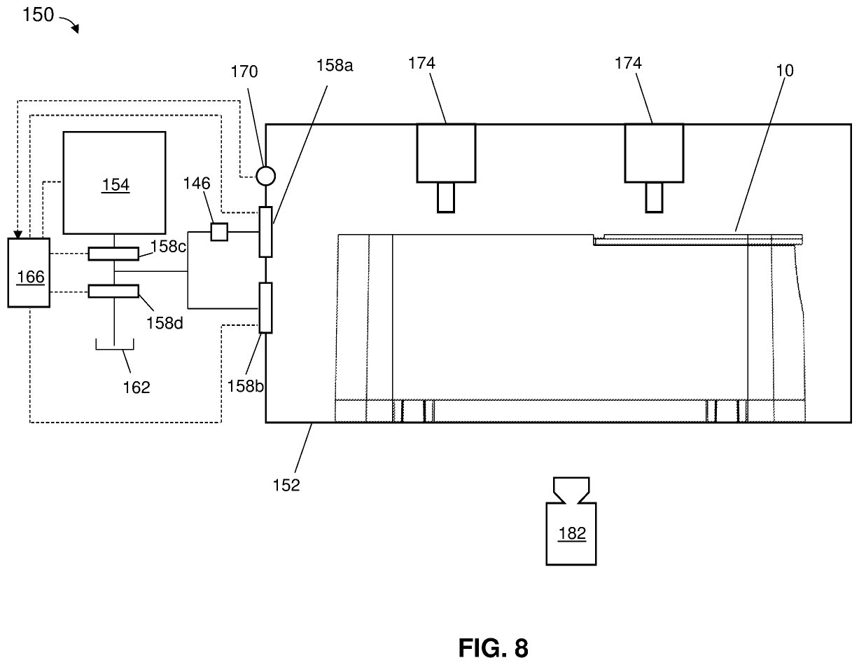

As shown, multiple chambers and test volumes can be loaded at the same time such that multiple reagents (e.g., multiple antibiotics) can be assessed along with a control. To do so, the pressure changes at the microfluidic device's inlet port(s) and at the chambers' first ports can brought about by disposing the device in a chamber and changing the pressure therein. By way of example, and referring to FIG. 8, shown is a system 150 that can be used to perform the above-described loading of the microfluidic device. System 150 can comprise a chamber 152 configured to receive and contain the microfluidic device. A pressure source 154 (e.g., a vacuum source) and one or more control valves 158a-158d can be configured to adjust the pressure within chamber 152. For example, when a vacuum source, pressure source 154 can be configured to remove gas from chamber 152 and thereby decrease the pressure therein (e.g., to below the ambient pressure) and thus at inlet port(s) 26 (and, once isolating members 78a-78c are open, at first port(s) 148a). The decreased pressure can facilitate gas evacuation of microfluidic circuit(s) 22. Each of control valve(s) 158a-158d can be movable between closed and open positions in which the control valve prevents and permits, respectively, fluid transfer between chamber 152, pressure source 154, and/or and external environment 162. For example, after a vacuum is generated in chamber 152, opening at least one of control valve(s) 158a-158d can permit gas to enter the vacuum chamber (e.g., from external environment 162) to increase the pressure therein (e.g., to the ambient pressure) and thus at inlet port(s) 26 (and, once isolating members 78a-78c are open, at reservoir(s) 74). The increased pressure can facilitate flow of aqueous sample into chamber(s) 34 and test volume(s) 98. While pressure source 154 can be a vacuum source to permit vacuum loading of microfluidic device 10, in other embodiments it can be a positive pressure source configured to increase pressure in chamber 152 (e.g., by introducing gas therein) to load the device using positive pressure.

System 150 can comprise a controller 166 configured to control pressure source 154 and/or control valve(s) 158a-158d to regulate pressure in chamber 152. Controller 166 can be configured to receive chamber pressure measurements from a pressure sensor 170. Based at least in part on those pressure measurements, controller 166 can be configured to activate pressure source 154 and/or at least one of control valve(s) 158a-158d, e.g., to achieve a target pressure within chamber 152 (e.g., with a proportional-integral-derivative controller). For example, control valve(s) 158a-158d of system 150 can comprise a slow valve 158a and a fast valve 158b, each—when in the open position—permitting fluid flow between chamber 158a and at least one of pressure source 154 and external environment 162. System 150 can be configured such that the maximum rate at which gas can flow through slow valve 158a is lower than that at which gas can flow through fast valve 158b. As shown, for example, system 150 comprises a restriction 146 in fluid communication with slow valve 158a. Controller 166 can control the rate at which gas enters or exits chamber 152—and thus the rate of change of pressure in the chamber—at least by selecting and opening at least one of slow valve 158a (e.g., for a low flow rate) and fast valve 158b (e.g., for a high flow rate) and closing the non-selected valve(s), if any. As such, suitable control can be achieved without the need for a variable-powered pressure source or proportional valves, although, in some embodiments, pressure source 154 can provide different levels of vacuum power and/or at least one of control valves 158a-158d can comprise a proportional valve.

Control valve(s) 158a-158d of system 150 can comprise a source valve 158c and a vent valve 158d. When pressure source 154 evacuates gas (if a vacuum source) or introduces gas (if a positive pressure source), source valve 158c can be opened and vent valve 158d can be closed such that the pressure source can draw gas from or drive gas into chamber 152 and the chamber is isolated from external environment 162. To return pressure in chamber 152 to ambient pressure, source valve 158c can be closed and vent valve 158d can be opened such that gas (e.g., air) can flow from external environment 162 into chamber 152 (if vacuum loading is used) or from the chamber into the external environment (if positive pressure loading is used). Slow and fast valves 158a and 158b can be in fluid communication with both source valve 158c and vent valve 158d such that controller 166 can adjust the flow rate in or out of chamber 152 with the slow and fast valves during both stages.

System 150 can also include one or more plungers 174 configured to engage penetrator assembly 90 of microfluidic device 10 through the device's opening(s) 178 such that penetrator(s) 94 open isolating member(s) 78a-78c as described above. And system 150 can include an optical sensor 182 (e.g., a camera) to analyze droplets in test volume(s) 98 as explained above. For example, microfluidic device 10's shell 14 can include one or more transparent portions through which optical sensor 182 can capture an image of droplets in test volume(s) 98 (FIG. 1E).

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A microfluidic device including a microfluidic circuit that comprises:
an inlet port;
a chamber configured to receive fluid from the inlet port, the chamber containing a reagent;
a first valve or frangible member having:
a closed position in which fluid is prevented from entering or exiting the chamber through the first valve or frangible member; and
an open position in which fluid is permitted to enter or exit the chamber through the first valve or frangible member;
a reservoir configured to receive liquid from the chamber, the reservoir containing a non-aqueous liquid;
a second valve or frangible member having:
a closed position in which fluid is prevented from flowing between the chamber and the reservoir through the second valve or frangible member; and
an open position in which fluid is permitted to flow between the chamber and the reservoir through the second valve or frangible member; and
a droplet-generating region configured to receive and produce droplets of liquid from the reservoir.

2. The microfluidic device of claim 1, wherein:
the microfluidic circuit comprises a third valve or frangible member that separates the chamber into a first portion and a second portion; and
the third valve or frangible member has:
a closed position in which gas, but not liquid, is permitted to flow between the first and second portions through the third valve or frangible member; and
an open position in which fluid is permitted to flow between the first and second portions through the third valve or frangible member.

3. The microfluidic device of claim 2, wherein the third valve or frangible member comprises an air-permeable membrane.

4. The microfluidic device of claim 3, wherein the air-permeable membrane comprises the reagent.

5. The microfluidic device of claim 1, wherein the first valve or frangible member comprises a first fluid-impermeable membrane.

6. The microfluidic device of claim 1, wherein the second valve or frangible member comprises a second fluid-impermeable membrane.

7. The microfluidic device of claim 3, wherein:
the first valve or frangible member comprises a first fluid-impermeable membrane;
the second valve or frangible member comprises a second fluid-impermeable membrane; and
the first fluid-impermeable membrane, the second fluid-impermeable membrane, and the air-permeable membrane are aligned such than an axis extends through each.

8. The microfluidic device of claim 6, wherein the first fluid-impermeable membrane and the second fluid-impermeable membrane are aligned such that an axis extends through each.

9. The microfluidic device of claim 7, comprising a penetrator that is movable relative to the membranes along the axis, the penetrator configured to puncture the membranes such that the membranes are in the open position.

10. The microfluidic device of claim 1, wherein the droplet-generating region includes a flow path having a minimum cross-sectional area that increases along the flow path in a direction away from the reservoir.

11. A method of loading a microfluidic device, the method comprising:
disposing an aqueous liquid within an inlet port of the microfluidic device;
introducing a reagent to the aqueous liquid at least by:
reducing pressure at the inlet port such that gas flows from a chamber of the microfluidic device that contains a reagent and out of the inlet port; and
increasing pressure at the inlet port such that at least a portion of the aqueous liquid flows from the inlet port and into the chamber; and
generating droplets of the aqueous liquid at least by:
opening first and second ports, each in fluid communication with the chamber;
reducing pressure at the first port such that gas flows:
from a droplet-generating region of the microfluidic device;
through a reservoir of the microfluidic device that contains a non-aqueous liquid; and
through the chamber via the first and second ports; and
increasing pressure at the first port such that at least a portion of the aqueous liquid and at least a portion of the non-aqueous liquid flow from the reservoir and through the droplet-generating region.

12. The method of claim 11, wherein:
the device comprises a valve or membrane in fluid communication with the chamber; and
increasing pressure at the inlet port is performed such that gas, but not liquid, flows through the valve or membrane.

13. The method of claim 11, wherein:
the device comprises a third valve or frangible member that separates the chamber into a first portion and a second portion; and
increasing pressure at the inlet port is performed such that gas, but not liquid, flows between the first and second portions through the third valve or frangible member.

14. The method of claim 13, wherein generating droplets of the aqueous liquid comprises opening the third valve or frangible member such that liquid is permitted to flow between the first and second portions through the third valve or frangible member.

15. The method of claim 11, wherein opening the first and second ports comprises:
opening a first valve or frangible member that otherwise prevents fluid from flowing through the first port and entering the chamber or exiting the chamber and flowing through the first port; and
opening a second valve or frangible member that otherwise prevents fluid from flowing through the second port and entering the chamber or exiting the chamber and flowing through the second port.

16. The method of claim 14, wherein, for each of the valves or frangible members:
the valve or frangible member comprises a membrane; and
opening the valve or frangible member comprises puncturing the membrane.

17. The method of claim 11, wherein the droplet-generating region includes a flow path having a minimum cross-sectional area that increases along the flow path in a direction away from the reservoir.

18. A device for introducing a liquid to a reagent, the liquid for receipt by a microfluidic chip, the device comprising:
a body having:
an interior volume; and
an end including a first opening in fluid communication with the interior volume; and
a reagent disposed within the interior volume;
wherein the body is configured to be coupled to a port of a microfluidic chip such that:
the end receives or is received by the port; and
the body includes a passageway configured to permit liquid to flow into the interior volume to contact the reagent without flowing out of the port.

19. The device of claim 18, wherein:
the body includes a second opening in fluid communication with the interior volume; and
the device comprises a first valve or frangible member having:
a closed position in which fluid is prevented from entering or exiting the interior volume through the first valve or frangible member; and
an open position in which fluid is permitted to enter and exit the interior volume through the first valve or frangible member.

20. The device of claim 18, comprising:
a second valve or frangible member that separates the interior volume into a first portion and a second portion, the second valve or frangible member having:
a closed position in which gas, but not liquid, is permitted to flow between the first and second portions through the second valve or frangible member; and
an open position in which fluid is permitted to flow between the first and second portions through the second valve or frangible member;
wherein the passageway is configured to permit liquid to flow into the first portion to contact the reagent without flowing out of the port.
